(19) United States
(12) Patent Application Publication
(10) Pub. No.: US 2017/0342328 A1
(43) Pub. Date: Nov. 30, 2017

(54) CHEMICAL EXTRACTION FROM AN AQUEOUS SOLUTION

(71) Applicant: Google Inc., Mountain View, CA (US)

(72) Inventors: Matthew D. Eisaman, Port Jefferson, NY (US); Stephen D. Karnitz, Farragut, TN (US); Jessica L.B. Rivest, Palo Alto, CA (US)

(21) Appl. No.: 15/204,212

(22) Filed: Jul. 7, 2016

Related U.S. Application Data
(60) Provisional application No. 62/342,065, filed on May 26, 2016.

(51) Int. Cl. C10G 2/00; B01D 61/42; C02F 1/469; C02F 1/52; C02F 1/66; C02F 103/08

(52) U.S. Cl. CPC C10G 2/50; C02F 1/5236; C02F 1/66; B01D 61/422; C02F 1/4693; C02F 2103/08

(57) ABSTRACT

A method of chemical extraction from an aqueous solution includes receiving an aqueous solution including dissolved inorganic carbon. The method also includes increasing a pH of a first portion of the aqueous solution to form a basic solution. The basic solution is then combined with a second portion of the aqueous solution to precipitate calcium salts. The calcium salts are then collected.

### REFERENCE TO RELATED APPLICATION

This application claims the benefit of U.S. Provisional Application No. 62/342,065 filed on May 26, 2016, the contents of which are incorporated herein by reference.

### TECHNICAL FIELD

This disclosure relates generally to chemical extraction.

### BACKGROUND INFORMATION

Pure carbon dioxide (CO₂) has many industrial uses. The separation of CO₂ from a mixed-gas source may be accomplished by a capture and regeneration process. More specifically, the process generally includes a selective capture of CO₂, by, for example, contacting a mixed-gas source with a solid or liquid adsorber/absorber followed by a generation or desorption of CO₂ from the adsorber/absorber. One technique describes the use of bipolar membrane electrodialysis for CO₂ extraction/removal from potassium carbonate and bicarbonate solutions.

For capture/regeneration systems, a volume of gas that is processed is generally inversely related to a concentration of CO₂ in the mixed-gas source, adding significant challenges to the separation of CO₂ from dilute sources such as the atmosphere. CO₂ in the atmosphere, however, establishes equilibrium with the total dissolved inorganic carbon in the oceans, which is largely in the form of bicarbonate ions (HCO₃₋) at an ocean pH of 8.1-8.3. Therefore, a method for extracting CO₂ from the dissolved inorganic carbon of the oceans would effectively enable the separation of CO₂ from atmosphere without the need to process large volumes of air.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. The drawings are not necessarily to scale, emphasis instead being placed upon illustrating the principles being described.

FIG. 1A is an illustration of a system for chemical extraction from an aqueous solution, in accordance with an embodiment of the disclosure.

FIG. 1B is an illustration of a system for chemical extraction from an aqueous solution, in accordance with an embodiment of the disclosure.

FIG. 1C is an illustration of a system for chemical extraction from an aqueous solution, in accordance with an embodiment of the disclosure.

FIG. 2 is an example electrodialysis unit, in accordance with an embodiment of the disclosure.

FIG. 3 is an illustration of a method for chemical extraction from an aqueous solution, in accordance with an embodiment of the disclosure.

### DETAILED DESCRIPTION

Embodiments of an apparatus and method for chemical extraction from an aqueous solution are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout the specification and claims, compounds/elements are referred to both by their chemical name (e.g., carbon dioxide) and chemical symbol (e.g., CO₂). It is appreciated that both chemical names and symbols may be used interchangeably and have the same meaning.

This disclosure provides for the removal of carbon from water sources containing dissolved inorganic carbon (e.g., bicarbonate ions HCO₃₋). The world's oceans act as carbon sinks absorbing large quantities of atmospheric carbon. As will be shown, systems and methods in accordance with the teachings of the present disclosure may be used to remove bicarbonate ions from the water and convert the ions into other useful materials. Removing excess carbon from the oceans may be both lucrative and environmentally restorative.

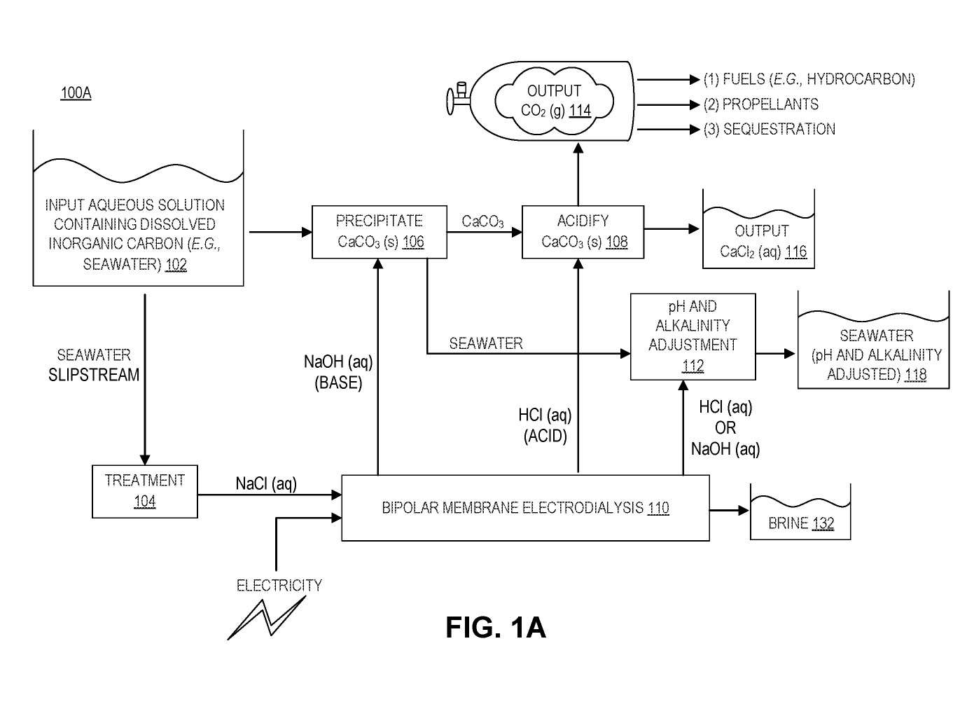

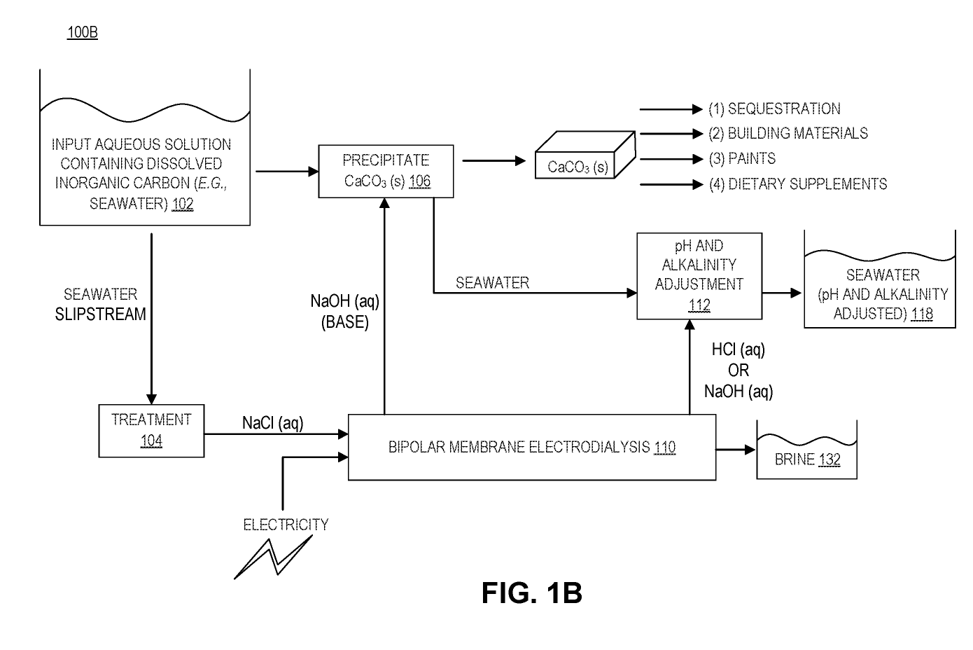

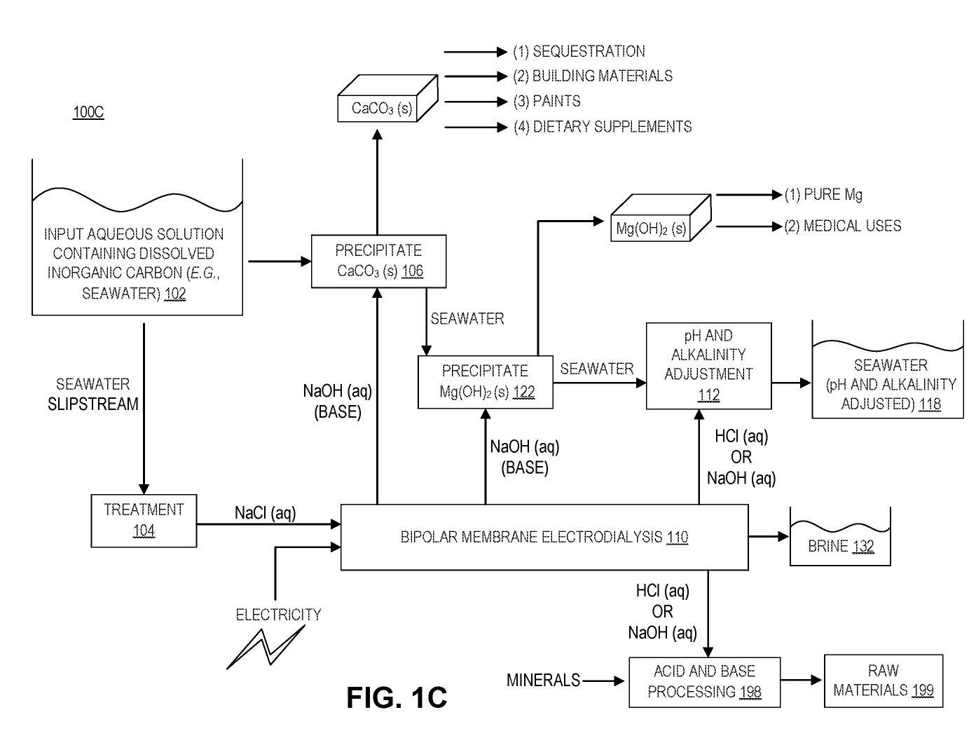

FIG. 1A is an illustration of a system 100A for chemical extraction from an aqueous solution, in accordance with an embodiment of the disclosure. System 100A includes: input 102 (to input an aqueous solution containing dissolved inorganic carbon), treatment unit 104, first precipitation unit 106, acidification unit 108, electrodialysis unit 110, pH adjustment unit 112, CO₂ gas collection unit 114, CaCl₂ output 116, water output 118, and brine output 132.

As shown, input 102 is coupled to a water reservoir containing dissolved inorganic carbon (e.g., bicarbonate ions). The water reservoir may be an ocean, lake, river, manmade reservoir, or brine outflow from a reverse osmosis (“RO”) process. Input 102 may receive the water through a system of channels, pipes, and/or pumps depending on the specific design of the facility. As shown, water received through input 102 is diverted into two separate sections of system 100A. A first (smaller) portion of the water is diverted to treatment unit 104, while a second (larger) portion of the water is diverted to first precipitation unit 106. One skilled in the art will appreciate that large aggregate may be removed from the water at any time during the intake process.

In the illustrated embodiment, the first portion of water is diverted into treatment unit 104. Treatment unit 104 outputs a relatively pure stream of aqueous NaCl. In other words, an aqueous solution (possibly including seawater) is input to treatment unit 104, and aqueous NaCl is output from treatment unit 104. Treatment unit 104 may be used to remove organic compounds and other minerals (other than NaCl) not needed in, or harmful to, subsequent processing steps. For example, removal of chemicals in the water may mitigate scale buildup in electrodialysis unit 110. Treatment unit 104 may include filtering systems such as: nanofilters, RO units, ion exchange resins, precipitation units, microfilters, screen filters, disk filters, media filters, sand filters, cloth filters, and biological filters (such as algae scrubbers), or the like. Additionally, treatment unit 104 may include chemical filters to removed dissolved minerals/ions. One skilled in the art will appreciate that any number of screening and/or filtering methods may be used by treatment unit 104 to remove materials, chemicals, aggregate, biologicals, or the like.

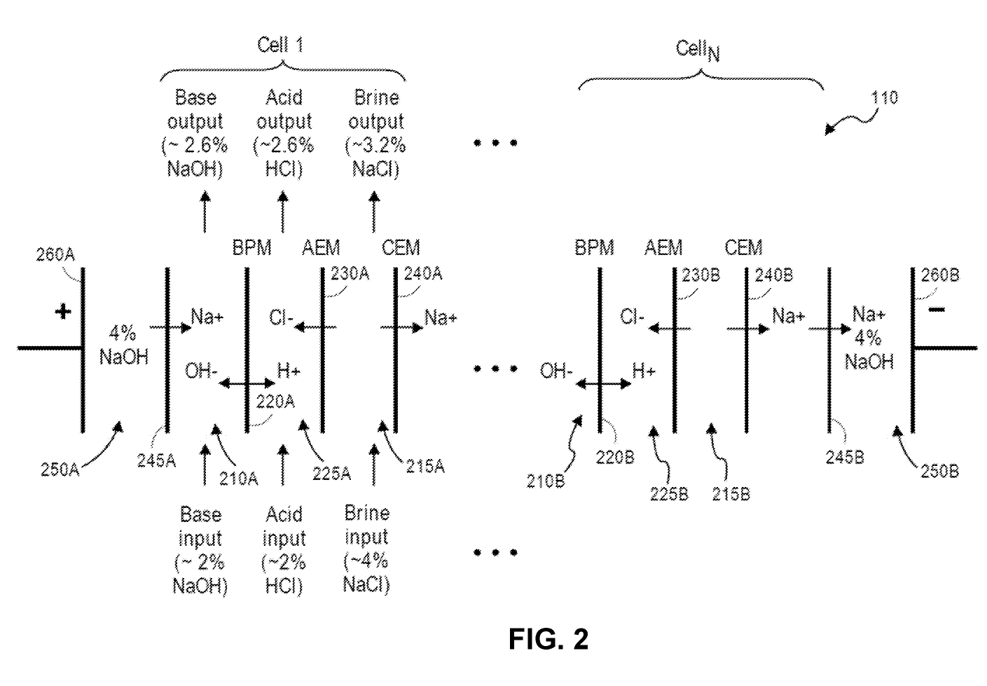

Electrodialysis unit 110 is coupled to receive aqueous NaCl and electricity, and output aqueous HCl, aqueous NaOH, and brine (to brine output 132). Aqueous HCl and aqueous NaOH output from electrodialysis unit 110 may be used to drive chemical reactions in system 100A. The specific design and internal geometry of electrodialysis unit 110 is discussed in greater detail in connection with FIG. 2 (see infra FIG. 2). Brine output from electrodialysis unit 110 may be used in any applicable portion of system 100A. For example, brine may be cycled back into electrodialysis unit 110 as a source of aqueous NaCl, or may be simply expelled from system 100A as wastewater.

In the illustrated embodiment, first precipitation unit 106 has a first input coupled to receive an aqueous solution including dissolved inorganic carbon (e.g., seawater) from input 102. First precipitation unit 106 also has a second input coupled to electrodialysis unit 110 to receive aqueous NaOH. In response to receiving the aqueous solution and the aqueous NaOH, first precipitation unit 106 precipitates calcium salts (for example, but not limited to, CaCO₃) and outputs the aqueous solution. However, in other embodiments, other chemical processes may be used to basify the aqueous solution in first precipitation unit 106. For example, other bases (not derived from the input aqueous solution) may be added to the aqueous solution to precipitate calcium salts.

In one embodiment, NaOH is added to incoming seawater until the pH is sufficiently high to allow precipitation of calcium salts without significant precipitation of Mg(OH)₂. The exact pH when precipitation of CaCO₃ occurs (without significant precipitation of Mg(OH)₂) will depend on the properties of the incoming seawater (alkalinity, temperature, composition, etc.); however, a pH of 9.3 is typical of seawater at a temperature of 25° C. In a different embodiment, the quantity of NaOH added is sufficient to precipitate CaCO₃ and Mg(OH)₂, then the pH is lowered (e.g., by adding HCl from electrodialysis unit 110 until the pH is <9.3) so that the Mg(OH)₂ (but not CaCO₃) redissolves.

In one embodiment, first precipitation unit 106 may be a large vat or tank. In other embodiments first precipitation unit 106 may include a series of ponds/pools. In this embodiment, precipitation of calcium salts may occur via evaporation driven concentration (for example using solar ponds) rather than, or in combination with, adding basic substances. First precipitation unit 106 may contain internal structures with a high surface area to promote nucleation of CaCO₃; these high surface area structures may be removed from the first precipitation unit 106 to collect nucleated CaCO₃. First precipitation unit 106 may include an interior with CaCO₃ to increase nucleation kinetics by supplying seed crystals. The bottom of first precipitation unit 106 may be designed to continually collect and extract precipitate to prevent large quantities of scale buildup.

In another or the same embodiment, heat may be used to aid precipitation. For example solar ponds may be used to heat basified water. In continuously flowing systems, low temperature waste heat solution may be flowed through heat exchange tubes with basified seawater on the outside of the tubes. Alternatively, heating the bottom of first precipitation unit 106 may be used to speed up precipitation.

After CaCO₃ is precipitated from the water, CaCO₃ is transferred to acidification unit 108. In the depicted embodiment, acidification unit 108 is coupled to receive CaCO₃ from first precipitation unit 106 and coupled to receive aqueous HCl from electrodialysis unit 110. In response to receiving CaCO₃ and aqueous HCl, acidification unit 108 produces CO₂. In the depicted embodiment, acidification unit 108 is used to evolve CaCO₃ into CO₂ gas and aqueous CaCl₂ according to the following reaction: CaCO₃(s)+2HCl(aq)→CaCl₂(aq)+H₂O(l)+CO₂(g). Reaction kinetics may be increased by agitating/heating the acidified mixture. By adding HCl to CaCO₃, CO₂ is spontaneously released due to the high equilibrium partial pressure of CO₂ gas. This may eliminate the need for membrane contactors or vacuum systems.

The example system 100A further includes gas collection unit 114 coupled to acidification unit 108 to collect the CO₂. Gas collection unit 114 may include one or more compressors (and/or gas purifiers) to contain evolved CO₂ in compressed gas cylinders. It is appreciated that concentrated CO₂ has many industrial uses including, but not limited to: a chemical precursor (e.g., for creating biofuels—by feeding the CO₂ to algae; for creating hydrocarbon fuels via hydrogenation of the CO₂ to methanol—by feeding the CO₂ along with steam into a solid oxide electrolysis cell to make syngas and subsequently using Fischer Tropsch reactions to make liquid hydrocarbons), as a food additive (e.g., drink carbonation), as an inert gas, etc. CO₂ extracted by the process disclosed here may be used in any of these applications and others not listed.

Once all CO₂ has been extracted from acidification unit 108, wastewater containing CaCl₂ is output from system 110A via CaCl₂ output 116. In one embodiment, the wastewater is returned to the ocean or other water source after the pH of the wastewater has been adjusted. In other embodiments, the wastewater maybe contained and further processed to remove other minerals.

In the depicted embodiment, the second portion of seawater (that was used as a carbon source in first precipitation unit 106) is flowed to a pH and alkalinity adjustment unit 112. The pH and alkalinity adjustment unit 112 is coupled to electrodialysis unit 110 to receive HCl and NaOH, and adjust a pH and alkalinity of the combined second portion of the aqueous solution and basic solution to a pH of seawater (or other environmentally safe pH value). In one embodiment, the pH and alkalinity of wastewater flowed into pH and alkalinity adjustment unit 112 is monitored in real time, and HCl or NaOH is flowed into pH and alkalinity adjustment unit 112 in response to the real time measurements. Adjusting the pH of wastewater flowing from system 100A ensures minimal environmental impact of running system 100A, while adjusting the alkalinity ensures sufficient reabsorption of atmospheric CO₂ once the water is returned to the ocean. Further, system 100A removes carbon from the oceans, improving ocean heath while producing economically viable raw materials.

FIG. 1B is an illustration of system 100B for chemical extraction from an aqueous solution, in accordance with an embodiment of the disclosure. System 100B is similar in many respects to system 100A of FIG. 1A. However, one major difference is system 100B does not include acidification unit 108, CO₂ gas collection unit 114, and CaCl₂ output 116. Alternatively, system 100B produces precipitated calcium salts as a raw material output.

It is appreciated that CaCO₃ has many industrial uses including (but not limited to): building materials (e.g., limestone aggregate for road building, an ingredient of cement, starting material for the preparation of builder's lime, etc.), dietary supplements (e.g., calcium supplement or gastric antacid), soil neutralizers, and the like. Calcium salts from the process shown in FIG. 1B may be used for any of these purposes and others not discussed such as sequestration of carbon by burying the CaCO₃.

FIG. 1C is an illustration of system 100C for chemical extraction from an aqueous solution, in accordance with an embodiment of the disclosure. System 100C is similar in many respects to systems 100A & 100B of FIGS. 1A & 1B. However, one major difference is that system 100C includes an additional precipitation step. Further, system 100C includes acid and base processing unit 198 and raw materials output 199.

In the depicted embodiment, system 100C includes second precipitation unit 122 with a first input coupled to receive the aqueous solution (e.g., seawater) from first precipitation unit 106, and a second input coupled to electrodialysis unit 110 to receive aqueous NaOH. In response to receiving the aqueous solution and the aqueous NaOH, second precipitation unit 122 precipitates magnesium salts (for example, but not limited to, Mg(OH)₂) and outputs the aqueous solution. In other words, after precipitating the CaCO₃, the pH of the second portion of the aqueous solution is adjusted to a second pH threshold where Mg(OH)₂ precipitates (e.g., a pH of 10.4). Like first precipitation unit 106, second precipitation unit 122 can use any number of structures/techniques to speed up nucleation kinetics of Mg(OH)₂. For example, second precipitation unit 122 may include high surface area inserts, Mg(OH)₂ seed crystals, or may be heated/cooled to promote nucleation of Mg(OH)₂.

The Mg(OH)₂ may be used in its natural state (e.g., medical applications such as to neutralize stomach acid), or may be converted into pure Mg and/or other compounds, depending on the desired use case.

As depicted, second precipitation unit 122 is coupled to output the spent aqueous solution to pH and alkalinity adjustment unit 112. As stated above in connection with discussion of FIG. 1A, pH and alkalinity adjustment unit 112 may be coupled to electrodialysis unit 110 to receive NaOH or HCl. The pH and alkalinity adjustment unit 112 may restore the pH and alkalinity of the wastewater to the same pH as the oceans for safe introduction of wastewater back into nature via water output 118. The pH and alkalinity adjustment unit 112 may also restore the alkalinity to a value that enables sufficient absorption of atmospheric CO2 once the water is returned to the ocean.

As illustrated, system 100C includes acid and base processing unit 198 and raw materials output 199. Acid and base processing unit 198 is coupled to receive NaOH and/or HCl from electrodialysis unit 110. Acid and base processing unit 198 may simply output (e.g., bottle and package) excess NaOH or HCl for sale, or may receive other minerals (e.g., silicate rock, Mg(OH)₂, magnesium silicates, etc.) through an input port to react with the acid/base and form other useful raw materials/elements. These raw materials and/or elements may be output from an output port and packaged for sale. In one embodiment, acid and base processing unit 198 may include bottling equipment to bottle the acids and bases for sale. One skilled in the art will recognize that any number of raw materials may be output from raw materials output 199; these materials may be sold or used for other purposes.

Although not depicted in FIGS. 1A-1C, in other embodiments, heavy metals may be extracted from the aqueous solution along with CaCO₃ and Mg(OH)₂. Extraction of heavy metals may help remove harmful contaminants from the world's oceans. Furthermore, extracted calcium and magnesium salts may be formed into blocks that can be placed in the ocean to form artificial reefs and breakwaters. In some low-lying islands, blocks of extracted Mg/Ca salts may be used to create land to combat rising sea levels. Ca/Mg salt blocks derived from seawater may be useful on coral-atolls where earth for landfill is already extremely scarce.

Systems 100A-100C may be coupled to, and run by, electronic control systems. Regulation and monitoring may be accomplished by a number of sensors throughout the system that either send signals to a controller or are queried by controller. For example, with reference to electrodialysis unit 110, monitors may include one or more pH gauges to monitor a pH within the units as well as pressure sensors to monitor a pressure among the compartments in electrodialysis unit 110 (to avoid inadvertent mechanical damage to electrodialysis unit 110). Another monitor may be a pH gauge placed within first precipitation unit 106 to monitor a pH within the tank. The signals from such pH monitor or monitors allows a controller to control a flow of brine solution (from input 102) and a basified solution (from electrodialysis unit 110) to maintain a pH value of a combined solution that will result in a precipitation of CaCO₃.

Alternatively, systems 100A-100C may be controlled manually. For example, a worker may open and close valves to control the various water, acid, and base flows in systems 100A-100C. Additionally, a worker may remove precipitated calcium salts from first precipitation unit 106. However, one skilled in the relevant art will appreciate that systems 100A-100C may be controlled by a combination of manual labor and mechanical automation, in accordance with the teachings of the present disclosure.

FIG. 2 is an example electrodialysis unit 110 (e.g., electrodialysis unit 110 of FIG. 1), in accordance with an embodiment of the disclosure. Electrodialysis unit 110 may be used to convert seawater (or other NaCl-containing aqueous solutions) into NaOH and HCL. As shown, in FIGS. 1A-1C, NaOH and HCl may be used to adjust the pH of the aqueous solution to precipitate calcium and magnesium salts.

In the depicted embodiment, electrodialysis unit 110 representatively consists of several cells in series, with each cell including a basified solution compartment (compartments 210A and 210B illustrated); an acidified solution compartment (compartments 225A and 225B illustrated); and a brine solution compartment (compartments 215A and 215B). FIG. 2 also shows a bipolar membrane (BPM) between a basified solution compartment and an acidified solution compartment (BPM 220A and 220B illustrated). A suitable BPM is a Neosepta BP-1E, commercially available from Ameridia Corp. Also depicted are anion exchange membranes (AEM), such as Neosepta ACS (commercially available from Ameridia Corp.), disposed between a brine compartment and an acidified solution compartment (AEM 230A and 230B illustrated). A cation exchange membrane (CEM) such as Neosepta CMX-S (commercially available from Ameridia Corp.), is disposed adjacent to a brine compartment (CEM 240A and CEM 240B illustrated). Finally, FIG. 2 shows end cap membranes 245A and 245B (such as Nafion® membranes) that separate the membrane stack from electrode solution compartment 250A and electrode solution compartment 250B, respectively.

Broadly speaking, under an applied voltage provided to electrodialysis unit 110, water dissociation inside the BPM (and the ion-selective membranes comprising a BPM) will result in the transport of hydrogen ions (H+) from one side of the BPM, and hydroxyl ions (OH−) from the opposite side. AEMs/CEMs, as their names suggest, allow the transport of negatively/positively charged ions through the membrane. The properties of these membranes such as electrical resistance, burst strength, and thickness are provided by the manufacturer (e.g., Neosepta ACS and CMX-S are monovalent-anion and monovalent-cation permselective membranes, respectively). In one embodiment, electrodialysis unit 110 includes electrodes 260A and 260B of, for example, nickel manufactured by De Nora Tech Inc. FIG. 2 also shows electrode solution compartment 250A and electrode solution compartment 250B through which, in one embodiment, a NaOH(aq) solution is flowed. Where electrode 260A is a positively-charged electrode, sodium ions (Na+) will be encouraged to move across cap membrane 245A and where electrode 260B is negatively-charged, sodium ions will be attracted to electrode solution compartment 250B. In one embodiment, the solution compartments between adjacent membranes are filled with polyethylene mesh spacers (e.g., 762 μm thick polyethylene mesh spacers), and these compartments are sealed against leaks using axial pressure and 794 mm thick EPDM rubber gaskets.

One skilled in the art will appreciate that using electrodialysis unit 110 to produce the acids and bases necessary to create Ca/Mg salts is highly advantageous in environments with ample power but limited raw materials. For example, on a coral atoll electrodialysis unit 110 could be powered by solar panels, allowing people on the atoll to create building materials from nothing but renewable energy and seawater.

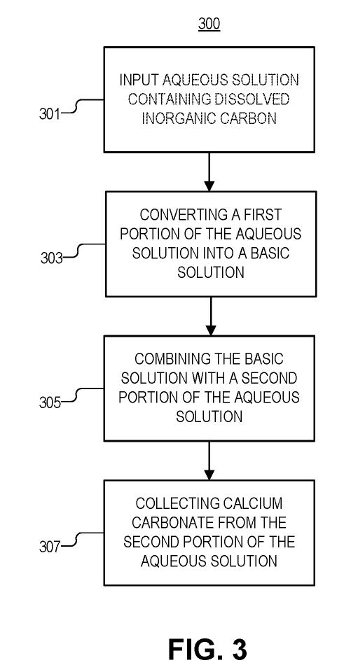

FIG. 3 is a flow chart illustrating a method 300 for chemical extraction from aqueous solutions, in accordance with an embodiment of the disclosure. The order in which some or all of process blocks 301-307 appear in method 300 should not be deemed limiting. Rather, one of ordinary skill in the art having the benefit of the present disclosure will understand that some of method 300 may be executed in a variety of orders not illustrated, or even in parallel. Additionally, method 300 may include additional blocks or have fewer blocks than shown, in accordance with the teachings of the present disclosure.

Block 301 illustrates receiving an aqueous solution including dissolved inorganic carbon. In one embodiment, this may include receiving seawater from the ocean or may include receiving water input/output from a power plant, water input/output from a treatment facility, or the like. It is appreciated that many industrial processes use large quantities of water. The process described herein may be coupled to many preexisting industrial systems and use the existing infrastructure to derive additional commercial gains (via valuable mineral/CO₂ extraction or the like). Accordingly, in practice intermediate steps may be present that relate to other industrial processes.

Block 303 shows converting a first portion of the aqueous solution into a basic solution. In one example, this may involve using electrodialysis equipment to convert aqueous NaCl into aqueous NaOH. However, in other embodiments, different chemical processes may be used to basify the first portion of the aqueous solution.

Block 305 discusses combining the basic solution with a second portion of the aqueous solution to precipitate calcium salts. In one embodiment, this occurs in a tank/vat with a high internal surface area to promote nucleation and growth of the calcium salts. For example, the tank/vat may have plate inserts which are used to collect the precipitated calcium salts. During the salt collection processes some of the nucleated calcium salt crystals may be left on the plate inserts to speed up nucleation in subsequent precipitation steps. In another embodiment, heat and evaporative concentration methods may be employed to enhance calcium salt nucleation from the second portion of the aqueous solution.

Block 307 illustrates collecting the calcium salts from the second portion of the aqueous solution. In one embodiment, collecting calcium salts is a continuous process where sites of nucleation are removed from the precipitation unit as they form. Alternatively, precipitated calcium slats may be collected batchwise. For example, a worker may remove collection plates/vessels from the precipitation unit once a sufficient quantity of calcium salts have nucleated on the plates/vessels.

Again, any portion of method 300 may be completed with low-tech or high-tech systems. For example, all of method 300 may be completed with computer controlled equipment and little or no manual intervention. Alternatively, method 300 may be performed by filling earthen ponds with seawater, and adjusting the pH of the ponds by manually adding acidic or basic solutions.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of chemical extraction from an aqueous solution, comprising:
receiving the aqueous solution including dissolved inorganic carbon;
increasing a pH of a first portion of the aqueous solution to form a basic solution;
combining the basic solution with a second portion of the aqueous solution to precipitate calcium salts; and
collecting the calcium salts from the second portion of the aqueous solution.

2. The method of claim 1, wherein the aqueous solution includes seawater, and wherein increasing the pH of the first portion of the aqueous solution to form the basic solution includes:
treating the first portion of the aqueous solution to produce aqueous NaCl; and
performing electrodialysis on the aqueous NaCl to produce aqueous NaOH, wherein the basic solution includes NaOH.

3. The method of claim 2, wherein combining the basic solution with the second portion of the aqueous solution includes adjusting a pH of the second portion of the aqueous solution to a first pH threshold where CaCO₃ precipitates from the second portion of the aqueous solution.

4. The method of claim 3, wherein the pH of the second portion of the aqueous solution is below a second pH threshold above which Mg(OH)₂ precipitates from the second portion of the aqueous solution.

5. The method of claim 3, further comprising:
after precipitating the calcium salts, adjusting the pH of the second portion of the aqueous solution above a second pH threshold above which Mg(OH)₂ precipitates from the second portion of the aqueous solution; and
precipitating magnesium salts.

6. The method of claim 1, further comprising acidifying the precipitated calcium salts to produce CO₂, wherein the precipitated calcium salts include CaCO₃.

7. The method of claim 6, further comprising producing hydrocarbons from the CO₂.

8. The method of claim 6, wherein acidifying the precipitated calcium salts includes:
treating the first portion of the aqueous solution to produce aqueous NaCl;
performing electrodialysis on the aqueous NaCl to produce aqueous HCl; and
applying the aqueous HCl to the precipitated calcium salts to produce CO₂ and aqueous CaCl₂.

9. The method of claim 8, wherein treating includes nanofiltration, precipitation, reverse osmosis, or ion exchange resins.

10. The method of claim 1, further comprising separating the precipitated calcium salts from the second portion of the aqueous solution and the basic solution.

11. The method of claim 1, further comprising adjusting a pH and alkalinity of the combined second portion of the aqueous solution and the basic solution to a desired pH and alkalinity, by mixing HCl or NaOH with the combined second portion of the aqueous solution and the basic solution.

12. A system for chemical extraction from an aqueous solution, comprising:
an electrodialysis unit coupled to receive aqueous NaCl, and output aqueous HCl and aqueous NaOH; and
a first precipitation unit with a first input coupled to receive the aqueous solution including dissolved inorganic carbon, and a second input coupled to the electrodialysis unit to receive the aqueous NaOH, wherein in response to receiving the aqueous solution and the aqueous NaOH, the first precipitation unit precipitates calcium salts and outputs the aqueous solution.

13. The system of claim 12, further comprising an acidification unit coupled to receive the calcium salts from the first precipitation unit and the aqueous HCl from the electrodialysis unit, wherein in response to receiving the calcium salts and the aqueous HCl, the acidification unit produces CO₂.

14. The system of claim 13, further comprising a gas collection unit coupled to the acidification unit to collect the CO₂.

15. The system of claim 12, further comprising a second precipitation unit with a first input coupled to receive the aqueous solution from the first precipitation unit, and a second input coupled to the electrodialysis unit to receive the aqueous NaOH, wherein in response to receiving the aqueous solution and the aqueous NaOH, the second precipitation unit precipitates magnesium salts and outputs the aqueous solution.

16. The system of claim 12, further comprising a pH and alkalinity adjustment unit coupled to receive the aqueous solution after the first precipitation unit, and coupled to receive the aqueous HCl or the aqueous NaOH from the electrodialysis unit, wherein in response to receiving the aqueous solution and the aqueous HCl or the aqueous NaOH, the pH and alkalinity adjustment unit adjust a pH and alkalinity of the aqueous solution to a desired pH and alkalinity.

17. The system of claim 12, further comprising a seawater intake coupled to the electrodialysis unit and the first precipitation unit wherein the aqueous solution includes seawater, and wherein the aqueous NaCl is extracted from the aqueous solution.

18. The system of claim 17, further comprising a treatment unit coupled between the seawater intake and the electrodialysis unit, and coupled to output the aqueous NaCl to the electrodialysis unit.

19. The system of claim 18, wherein the treatment unit includes nanofiltration, precipitation, reverse osmosis, or ion exchange resins.

20. The system of claim 12, wherein the first precipitation unit has an interior including CaCO₃ to increase nucleation kinetics of the calcium salts from the aqueous solution.

21. The system of claim 12, further comprising an acid and base processing unit, including bottling equipment, coupled to the electrodialysis unit to receive at least one of the aqueous NaOH or the aqueous HCl, wherein the bottling equipment bottles at least one of the aqueous NaOH or the aqueous HCl.

22. The system of claim 21, wherein the acid and base processing unit includes an input port coupled to receive minerals and an output port coupled to output raw materials.
